(19) United States
(12) Patent Application Publication
(10) Pub. No.: US 2025/0193102 A1
(43) Pub. Date: Jun. 12, 2025

(54) ACCELERATED TRACEROUTE USING HEADER FIELD AND METADATA

(71) Applicant: Cisco Technology, Inc., San Jose, CA (US)

(72) Inventors: Jaganbabu Rajamanickam, Kanata (CA); Darren Russell Dukes, Ottawa (CA); Madhan Sankaranarayanan, Nadu (IN); Nagendra Kumar Nainar, Morrisville, NC (US); Amit Tamang, Ottawa (CA)

(21) Appl. No.: 18/398,807

(22) Filed: Dec. 28, 2023

Related U.S. Application Data
(63) Continuation of application No. 18/532,266, filed on Dec. 7, 2023, now abandoned.

(51) Int. Cl. H04L 43/10; H04L 69/22

(52) U.S. Cl. CPC H04L 43/10; H04L 69/22

(57) ABSTRACT

The present technology provides solutions for identifying a route that a packet traverses. An example method includes sending, from a head-end, a packet towards a reserved port at a tail-end, the packet having a header and a time-to-live (TTL) parameter, receiving, at the head-end, an error packet identifying a hop limit, sending, from the head-end towards the tail-end, a set of packets to be traced, receiving, at the head-end, corresponding error packets identifying a number of hops to reach a corresponding node based on the varying TTL parameters, and generating, based on the corresponding error packets and the corresponding headers, the route from the head-end to the tail-end. Systems and computer-readable media are also provided.

### CROSS-REFERENCES TO RELATED APPLICATIONS

This application is a continuation of U.S. application Ser. No. 18/532,266, filed on Dec. 7, 2023, which is hereby incorporated by reference in its entirety.

### TECHNICAL FIELD

The present technology relates to an accelerated traceroute and more particularly to an accelerated traceroute using unique headers and metadata.

### BACKGROUND

Traceroute is one of the main operations, administration, and/or maintenance (OAM) tools used to trace paths between a source and a destination. Traceroute is typically supported on most, if not all, nodes in a network by sending Internet Control Message Protocol (ICMP) errors when time-to-live (TTL) expires. Traceroute can be used to support black hole detection and identify end-to-end paths. With recent development in various underlay and/or overlay technologies, many OAM tools are being developed based on tracing the underlay and/or overlay nodes on the path between a source and destination.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example workflow in accordance with some aspects of the present technology;

FIG. 2 illustrates a block diagram of an example method in accordance with some aspects of the present technology; and

FIG. 3 shows an example of a system for implementing certain aspects of the present technology.

### DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

In at least one aspect, a method of identifying a route that a packet traverses, the method includes sending, from a head-end, a packet towards a reserved port at a tail-end, the packet having a header and a time-to-live (TTL) parameter, receiving, at the head-end, an error packet identifying a hop limit, where the hop limit is a number of hops to reach the tail-end from the head-end, sending, from the head-end towards the tail-end, a set of packets to be traced, where the set of packets have varying TTL parameters and corresponding headers with unique header lengths for each packet in the set of packets, receiving, at the head-end, corresponding error packets identifying a number of hops to reach a corresponding node based on the varying TTL parameters, and generating, based on the corresponding error packets and the corresponding headers, the route from the head-end to the tail-end.

In at least one other aspect, the varying TTL parameters are between 1 and the number of hops to reach the tail-end.

In at least one other aspect, a number of the packets in the set of packets is the number of hops to reach the tail-end.

In at least one other aspect, the method may also include determining, based on the corresponding error packets and the unique header lengths, an order for each of the corresponding nodes, where generating the route from the head-end to the tail-end is further based on the order for each of the corresponding nodes.

In at least one other aspect, the packet is a user datagram protocol (UDP) packet and the error packet is an internet control message protocol (ICMP) error packet.

In at least one other aspect, the set of packets are sent without waiting for receipt of any of the corresponding error packets.

In at least one other aspect, the method may also include determining, at the head-end, that the TTL parameter has not been exceeded, sending, from the head-end, at least one subsequent packet, where each of the at least one subsequent packet includes a subsequent TTL parameter higher than the TTL parameter, and receiving, at the head-end, at least one subsequent error packet identifying a hop limit of the at least one subsequent packet, and where the hop limit is based on the at least one subsequent error packet.

In at least one aspect, a system includes a processor and a non-transitory memory storing computer-executable instructions thereon, where the computer-executable instructions, when executed by the processor, cause the processor to perform operations including sending, from a head-end, a packet towards a reserved port at a tail-end, the packet having a header and a time-to-live (TTL) parameter, receiving, at the head-end, an error packet identifying a hop limit, where the hop limit is a number of hops to reach the tail-end from the head-end, sending, from the head-end towards the tail-end, a set of packets to be traced, where the set of packets have varying TTL parameters and corresponding headers with unique header lengths for each packet in the set of packets, receiving, at the head-end, corresponding error packets identifying a number of hops to reach a corresponding node based on the varying TTL parameters, and generating, based on the corresponding error packets and the corresponding headers, the route from the head-end to the tail-end.

In at least one aspect, a non-transitory computer-readable medium storing instructions thereon, where the instructions, when executed by one or more processors, cause the one or more processors to perform operations includes sending, from a head-end, a packet towards a reserved port at a tail-end, the packet having a header and a time-to-live (TTL) parameter, receiving, at the head-end, an error packet identifying a hop limit, where the hop limit is a number of hops to reach the tail-end from the head-end, sending, from the head-end towards the tail-end, a set of packets to be traced, where the set of packets have varying TTL parameters and corresponding headers with unique header lengths for each packet in the set of packets, receiving, at the head-end, corresponding error packets identifying a number of hops to reach a corresponding node based on the varying TTL parameters, and generating, based on the corresponding error packets and the corresponding headers, the route from the head-end to the tail-end.

### DESCRIPTION

Traceroute is one of the main operations, administration, and/or maintenance (OAM) tools used to trace paths between a source and a destination. Traceroute is typically supported on most, if not all, nodes in a network by sending Internet Control Message Protocol (ICMP) errors when time-to-live (TTL) expires. Traceroute can be used to support black hole detection and identify end-to-end paths. With recent development in various underlay and/or overlay technologies, many OAM tools are being developed based on tracing the underlay and/or overlay nodes on the path between a source and destination.

Apart from finding failing nodes between a source and a destination, traceroute can also identify the paths that a packet traverses between a source and a destination for various observability and capacity planning purposes.

While helpful, the current traceroute is limited in speed. More specifically, the current traceroute is performed by sending a probe, receiving a response, incrementing the TTL, and serially repeating these steps for every node in the path. Accordingly, the time taken to perform a traceroute is the sum of the round trip times between the source and each node in the path to a destination. In other words, as more hops are performed (e.g., more nodes between the source and the destination), the time required for the traceroute is exponentially longer due to longer and longer round trips between the source and farther nodes. This results in the current traceroute taking long amounts of time.

The disclosed technology addresses the need in the art for an accelerated traceroute. The accelerated traceroute disclosed can asynchronously send packets to nodes between a head-end (e.g., a source) and a tail-end (e.g., a destination). In other words, the time to perform the accelerated traceroute can be significantly shorter than the time required for the current traceroute methods. For example, the current traceroute methods would require a sum of the round-trip times between a source node and a first intermediate node, the source node and a second intermediate, the source node and other intermediate nodes, and the source node and a destination. However, the disclosed accelerated traceroute can send packets to multiple nodes without waiting for each intermediate node to respond, shortening the required amount of time to a longest round trip time between the source node and any other node.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

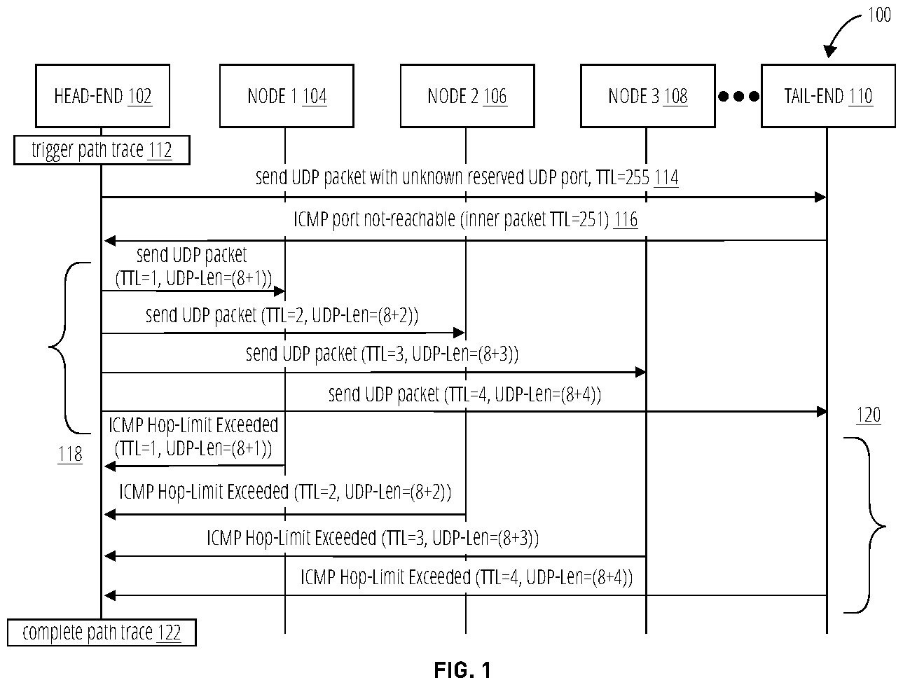

FIG. 1 illustrates an example workflow 100 for performing an accelerated traceroute. More specifically, a head-end 102 (e.g., a source) is configured to perform an accelerated traceroute for a packet sent to a tail-end 110 (e.g., a destination). For example, the head-end 102 can send a packet and/or a probe through one or more intermediate nodes 104, 106, 108 to a destination (e.g., the tail-end 110). While the present disclosure is described with respect to UDP packets, hop-limits, and TTLs, the present technology can be adapted to other forms of communication.

When a path trace or traceroute is triggered 112, head-end 102 can send 114 a UDP packet with an unknown reserved port. Additionally, the head-end 102 can set a TTL for the UDP packet to be a hop limit large enough to reach the tail-end 110. For example, the head-end 102 can set the TTL for the UDP packet as 255.

When the packet reaches the tail-end 110, the tail-end 110 can respond 116 by sending an ICMP message indicating that a port for a next hop is not reachable. Since the TTL is large enough for the packet to reach the tail-end 110, the packet will reach the tail-end 110. However, the packet will not be able to continue onwards and therefore fail to continue beyond the tail-end 110. In other words, the packet will not be able to reach the unknown reserved port. Accordingly, the ICMP message can identify a number of hops (N) that the UDP packet traversed to reach the tail-end 110 from the head-end 102. In other words, the tail-end 110 is the Nth node traversed by the packet. For example, the TTL for the packet above was set at 255. However, the packet only required 251 hops to reach the tail-end 110 from the head-end 102. In other words, the tail-end is the 251st node traversed by the packet and N=251. Accordingly, the ICMP message can identify, in a part of a payload of the ICMP message, that the packet traversed 251 nodes to reach the tail-end 110.

In some scenarios, the head-end 102 may not receive a port unreachable response from the tail-end 110. For example, the ICMP port may actually be reachable and/or the TTL was actually exceeded (e.g, the TTL was not large enough for the packet to reach the tail-end 110). In these scenarios, the head-end 102 can send a burst of probes with varying TTLs. For example, the head-end 102 can send a burst of probes with TTLs of 1-10. If there is no response from the 10th node, the head-end 102 can send another burst of probes with TTLs of 11-20. The head-end 102 can continue sending bursts of probes with higher TTLs until there is no response or until receipt of a port unreachable message.

The head-end 102 can then send a burst of trace probes 118 to the intermediate nodes 104, 106, 108 and the tail-end 110. Upon receipt, each of the intermediate nodes 104, 106, 108 and the tail-end 110 respond 120 with messages (e.g., error messages) to respective trace probes.

The trace probes can include varying TTLs and identifiers. The varying TTLs ensure that each trace probe reaches the various nodes between the head-end 102 and the tail-end 110. The head-end 102 utilizes the identifiers to determine which packet and node a particular ICMP message (e.g., a hop-limit-exceeded error message) is associated with. In other words, the identifiers can be used to facilitate determining which message belongs to each node.

Various different identifiers can be used for the trace probes to determine which node provided a particular response. For example, the head-end 102 can set unique UDP-lengths for each probe of the burst of probes. More specifically, the head-end can, based on the total number of hops between the head-end 102 and the tail-end 110 (e.g., as identified by the ICMP response message), include a TTL value of 1 for a first trace probe, a TTL value of 2 for a second trace probe, a TTL value of 3 for a third trace probe, and continue in this fashion until reaching a TTL value based on the total number of hops (e.g., 251 in the example above) for a final trace probe. Accordingly, the UDP-lengths can be some value with the TTL added thereto. For example, FIG. 1 illustrates the head-end 102 sending a UDP packet with TTL=1 and a UDP-length of 8+1, to indicate that the packet is being sent one hop away. Consequently, a response to this packet would identify that the hop-limit would be exceeded after node 1 104. Similarly, FIG. 1 illustrates sending packets to node 2 106 with TTL=2 and UDP-length of 8+2 and to node 3 with TTL=3 and UDP-length of 8+3. In some embodiments, the packet may identify the tail-end 110 as the Nth node. Accordingly, the TTL would be equal to N and have a UDP-length of 8+N. In other words, the different values in the UDP-length can identify the packet and, consequently, responses thereto.

As another example, ICMPv6 can include error codes indicating parameter specific problems in an IPV6 header. The head-end 102 can craft a probe with parameter problems that are only recognized by the head-end 102. For example, the head-end 102 can set different unrecognized next-hop values or attributes in different probes (e.g., in a segment routing header (SRH), and/or in a chain if the attribute is within a size that would be returned back by intermediate nodes). As another example, in the presence of SRH, the head-end 102 can utilize a type-length-value (TLV) field that can carry different values that only the head-end 102 can decipher.

As another example, a SRH segment-list field can be used to append locally-decipherable security identifier (SID) values that only the source (i.e., the head-end 102) would understand. For example, a segments-left field can be set to 5, but the segments-left list will have 6 and the bottom-most value can be a unique value understandable only by the source. Similarly, a tag field of the SRH can be used to contain the unique identifier.

Generally, extension headers or upper layer headers can be used to carry the identifier and one of ordinary skill in the art would understand that the above examples are provided for explanation and discussion purposes only.

After the head-end 102 receives all of the probe responses and/or error messages from the nodes 104, 106, 108 and the tail-end 110, the head-end 102 can complete 122 the path trace by generating a path for the probes based on the identifiers. For example, the head-end 102 can identify node 1 104 as the first node that packet traverses based on an ICMP error message identifying that the hop-limit was exceeded at the node 1 104 and that the value of the hop limit was 1. In other words, the head-end 102 determines an order of the nodes based on the responses, and the head-end 102 uses the order to generate the path for the packet. Furthermore, due to respective nodes being identifiable based on the unique identifiers, the head-end 102 can receive the probe responses asynchronously and generate the path continuously as the head-end 102 receives the responses.

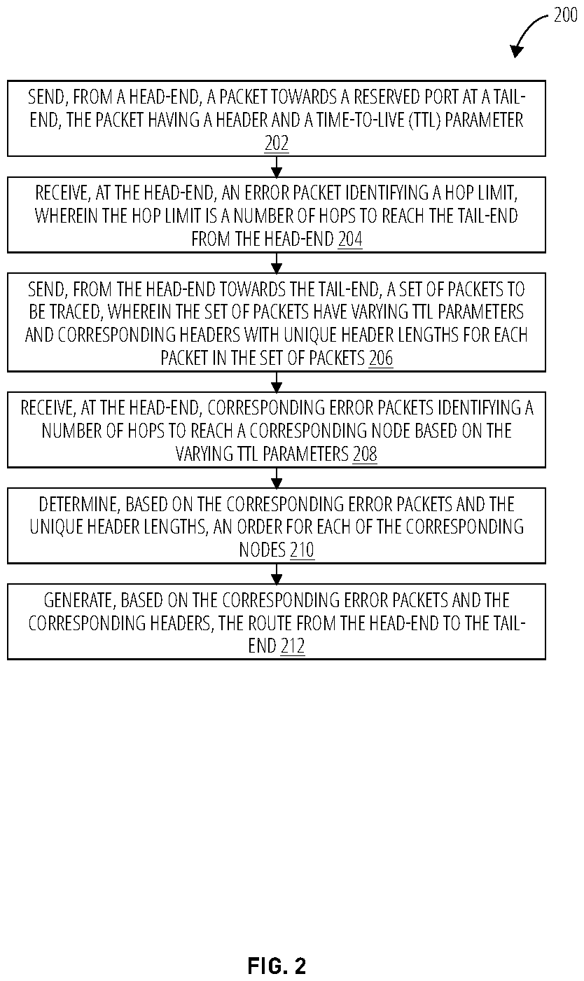

FIG. 2 illustrates an example method 200 for tracing a path that a data packet traverses between a head-end 102 and a tail-end 110. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

At step 202, method 200 can include sending, from a head-end, a packet towards a reserved port at a tail-end, the packet having a header and a time-to-live (TTL) parameter. In some embodiments, the packet is a UDP packet.

In some embodiments, method 200 can include determining, at the head-end, that the TTL parameter has not been exceeded.

In some embodiments, method 200 can include sending, from the head-end, at least one subsequent packet, wherein each of the at least one subsequent packet includes a subsequent TTL parameter higher than the TTL parameter.

In some embodiments, method 200 can include receiving, at the head-end, at least one subsequent error packet identifying a hop limit of the at least one subsequent packet, and wherein the hop limit is based on the at least one subsequent error packet.

At step 204, method 200 can include receiving, at the head-end, an error packet identifying a hop limit, wherein the hop limit is a number of hops to reach the tail-end from the head-end. In some embodiments, the error packet is an ICMP error packet.

At step 206, method 200 can include sending, from the head-end towards the tail-end, a set of packets to be traced, wherein the set of packets have varying TTL parameters and corresponding headers with unique header lengths for each packet in the set of packets. In some embodiments, the varying TTL parameters are between one and the number of hops to reach the tail-end from the head-end. In some embodiments, a number of the packets in the set of packets is the number of hops to reach the tail-end from the head-end. In some embodiments, the set of packets are sent without waiting for receipt of any of the corresponding error packets.

At step 208, method 200 can include receiving, at the head-end, corresponding error packets identifying a number of hops to reach a corresponding node based on the varying TTL parameters.

In some embodiments, method 200 can include determining, based on the corresponding error packets and the unique header lengths, an order for each of the corresponding nodes at step 210.

At step 212, method 200 can include generating, based on the corresponding error packets and the corresponding headers, the route from the head-end to the tail-end. In some embodiments, generating the route from the head-end to the tail-end is further based on the order for each of the corresponding nodes.

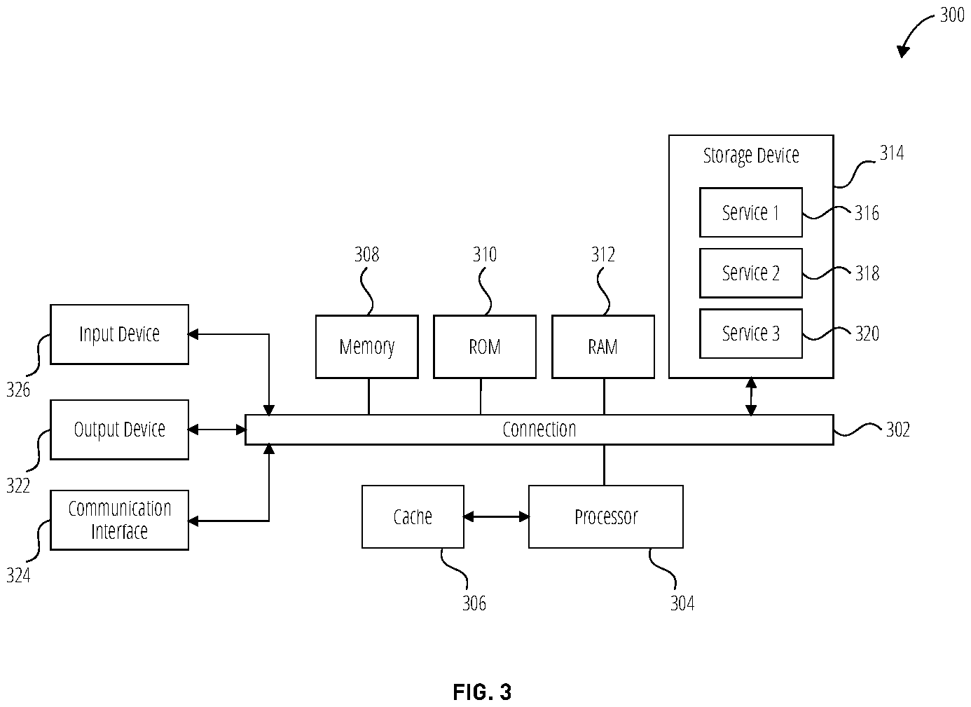

FIG. 3 shows an example of computing system 300, which can be for example any computing device making up head-end 102, nodes 104, 106, 108, tail-end 110, or any component thereof in which the components of the system are in communication with each other using connection 302. Connection 302 can be a physical connection via a bus, or a direct connection into processor 304, such as in a chipset architecture. Connection 302 can also be a virtual connection, networked connection, or logical connection.

In some embodiments, computing system 300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 300 includes at least one processing unit (CPU or processor) 304 and connection 302 that couples various system components including system memory 308, such as read-only memory (ROM) 310 and random access memory (RAM) 312 to processor 304. Computing system 300 can include a cache of high-speed memory 306 connected directly with, in close proximity to, or integrated as part of processor 304.

Processor 304 can include any general purpose processor and a hardware service or software service, such as services 316, 318, and 320 stored in storage device 314, configured to control processor 304 as well as a special-purpose processor where software instructions are incorporated into the actual processor design. Processor 304 may essentially be a completely self-contained computing system, containing multiple cores or processors, a bus, memory controller, cache, etc. A multi-core processor may be symmetric or asymmetric.

To enable user interaction, computing system 300 includes an input device 326, which can represent any number of input mechanisms, such as a microphone for speech, a touch-sensitive screen for gesture or graphical input, keyboard, mouse, motion input, speech, etc. Computing system 300 can also include output device 322, which can be one or more of a number of output mechanisms known to those of skill in the art. In some instances, multimodal systems can enable a user to provide multiple types of input/output to communicate with computing system 300. Computing system 300 can include communication interface 324, which can generally govern and manage the user input and system output. There is no restriction on operating on any particular hardware arrangement, and therefore the basic features here may easily be substituted for improved hardware or firmware arrangements as they are developed.

Storage device 314 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 314 can include software services, servers, services, etc., that when the code that defines such software is executed by the processor 304, it causes the system to perform a function. In some embodiments, a hardware service that performs a particular function can include the software component stored in a computer-readable medium in connection with the necessary hardware components, such as processor 304, connection 302, output device 322, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of identifying a route that a data packet traverses, the method comprising:
sending, from a head-end, a packet towards a reserved port at a tail-end, the packet having a header and a time-to-live (TTL) parameter;
receiving, at the head-end, an error packet identifying a hop limit, wherein the hop limit is a number of hops to reach the tail-end from the head-end;
sending, from the head-end towards the tail-end, a set of packets to be traced, wherein the set of packets have varying TTL parameters and corresponding headers with unique header lengths for each packet in the set of packets;
receiving, at the head-end, corresponding error packets identifying a number of hops to reach a corresponding node based on the varying TTL parameters; and
generating, based on the corresponding error packets and the corresponding headers, the route from the head-end to the tail-end.

2. The method of claim 1, wherein the varying TTL parameters are between 1 and the number of hops to reach the tail-end.

3. The method of claim 1, wherein a number of the packets in the set of packets is the number of hops to reach the tail-end.

4. The method of claim 1, the method further comprising:
determining, based on the corresponding error packets and the unique header lengths, an order for each of the corresponding nodes,
and wherein generating the route from the head-end to the tail-end is further based on the order for each of the corresponding nodes.

5. The method of claim 1, wherein the packet is a user datagram protocol (UDP) packet and the error packet is an internet control message protocol (ICMP) error packet.

6. The method of claim 1, wherein the set of packets are sent without waiting for receipt of any of the corresponding error packets.

7. The method of claim 1, the method further comprising:
determining, at the head-end, that the TTL parameter has not been exceeded;
sending, from the head-end, at least one subsequent packet, wherein each of the at least one subsequent packet includes a subsequent TTL parameter higher than the TTL parameter; and
receiving, at the head-end, at least one subsequent error packet identifying a hop limit of the at least one subsequent packet, and wherein the hop limit is based on the at least one subsequent error packet.

8. A system comprising:
a processor; and
a non-transitory memory storing computer-executable instructions thereon, wherein the computer-executable instructions, when executed by the processor, cause the processor to perform operations comprising:
sending, from a head-end, a packet towards a reserved port at a tail-end, the packet having a header and a time-to-live (TTL) parameter;
receiving, at the head-end, an error packet identifying a hop limit, wherein the hop limit is a number of hops to reach the tail-end from the head-end;
sending, from the head-end towards the tail-end, a set of packets to be traced, wherein the set of packets have varying TTL parameters and corresponding headers with unique header lengths for each packet in the set of packets;
receiving, at the head-end, corresponding error packets identifying a number of hops to reach a corresponding node based on the varying TTL parameters; and
generating, based on the corresponding error packets and the corresponding headers, a route that the packet traverses from the head-end to the tail-end.

9. The system of claim 8, wherein the varying TTL parameters are between 1 and the number of hops to reach the tail-end.

10. The system of claim 8, wherein a number of the packets in the set of packets is the number of hops to reach the tail-end.

11. The system of claim 8, wherein the computer-executable instructions, when executed by the processor, cause the processor to further perform operations comprising:
determining, based on the corresponding error packets and the unique header lengths, an order for each of the corresponding nodes,
and wherein generating the route from the head-end to the tail-end is further based on the order for each of the corresponding nodes.

12. The system of claim 8, wherein the packet is a user datagram protocol (UDP) packet and the error packet is an internet control message protocol (ICMP) error packet.

13. The system of claim 8, wherein the set of packets are sent without waiting for receipt of any of the corresponding error packets.

14. The system of claim 8, wherein the computer-executable instructions, when executed by the processor, cause the processor to further perform operations comprising:
determining, at the head-end, that the TTL parameter has not been exceeded;
sending, from the head-end, at least one subsequent packet, wherein each of the at least one subsequent packet includes a subsequent TTL parameter higher than the TTL parameter; and
receiving, at the head-end, at least one subsequent error packet identifying a hop limit of the at least one subsequent packet, and wherein the hop limit is based on the at least one subsequent error packet.

15. A non-transitory computer-readable medium storing instructions thereon, wherein the instructions, when executed by one or more processors, cause the one or more processors to perform operations comprising:
sending, from a head-end, a packet towards a reserved port at a tail-end, the packet having a header and a time-to-live (TTL) parameter;
receiving, at the head-end, an error packet identifying a hop limit, wherein the hop limit is a number of hops to reach the tail-end from the head-end;
sending, from the head-end towards the tail-end, a set of packets to be traced, wherein the set of packets have varying TTL parameters and corresponding headers with unique header lengths for each packet in the set of packets;
receiving, at the head-end, corresponding error packets identifying a number of hops to reach a corresponding node based on the varying TTL parameters; and
generating, based on the corresponding error packets and the corresponding headers, a route that the packet traverses from the head-end to the tail-end.

16. The non-transitory computer-readable medium of claim 15, wherein the varying TTL parameters are between 1 and the number of hops to reach the tail-end.

17. The non-transitory computer-readable medium of claim 15, wherein a number of the packets in the set of packets is the number of hops to reach the tail-end.

18. The non-transitory computer-readable medium of claim 15, wherein the instructions, when executed by the one or more processors, cause the one or more processors to further perform operations comprising:
determining, based on the corresponding error packets and the unique header lengths, an order for each of the corresponding nodes,
and wherein generating the route from the head-end to the tail-end is further based on the order for each of the corresponding nodes.

19. The non-transitory computer-readable medium of claim 15, wherein the packet is a user datagram protocol (UDP) packet and the error packet is an internet control message protocol (ICMP) error packet.

20. The non-transitory computer-readable medium of claim 15, wherein the set of packets are sent without waiting for receipt of any of the corresponding error packets.
